(19) United States
(12) Patent Application Publication
(10) Pub. No.: US 2008/0004067 A1
(43) Pub. Date: Jan. 3, 2008

(54) CONTROLLING A MOBILE DEVICE

(75) Inventors: Antti Piipponen, Tampere (FI); Kalle Raiskila, Vantaa (FI); Tommi Zetterman, Helsnki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/565,042

(22) Filed: Nov. 30, 2006

(30) Foreign Application Priority Data
Jun. 30, 2006 (GB) GB 0613118.9

(51) Int. Cl. H04M 1/00

(52) U.S. Cl. 455/550.1

(57) ABSTRACT

A mobile device and method for controlling operation thereof is disclosed. The mobile device comprises at least one measurement element for producing temperature measurement information. A controller is also provided, the controller being configured to control performance of at least one function of the mobile device in response to the temperature measurement information.

The present invention relates generally to mobile devices, and in particular to control of operation of a mobile device, such as a mobile communication device for communication via a wireless interface or otherwise. The control considers in particular power consumption and/or heat generation of the device.

A communication device is a device provided with appropriate communication and control capabilities for enabling use thereof for communication with others devices. The communication may comprise, for example, communication of voice, electronic mail (email), text messages, data, multimedia and so on. The communication device may comprise any device facilitating sending and/or receiving communication, for example an appropriate mobile user equipment or a mobile station and so on. A communication device typically enables a user of the device to receive and transmit communications via a communication system.

A communication system is a facility which facilitates the communication between two or more entities such as communication device, network entities and other nodes. A communication system is typically operated in accordance with particular communication protocols and/or parameters. For example, the manner in which communication should be implemented between a communication device and elements of a communication network is typically based on a predefined communication protocol. A communication device needs typically be adapted to be enabled for communication in accordance with a particular protocol.

A communication device can access a communications system via a fixed line or wireless communication interface. Communication systems providing wireless access enable at least some degree of mobility for the users thereof. An example of communication networks providing wireless access and mobility is a public land mobile network (PLMN). Non-limiting examples of possible mobile networks include the GSM (Global System for Mobile communications), the GPRS (General Packet Radio Service), the WCDMA (Wideband Code Division Multiple Access) or EDGE (Enhanced Data for GSM Evolution) and so forth. Other examples of wireless access technologies include various different wireless local area networks (WLANs) and satellite based communication systems.

A communication device may be configured to be compatible with different access technologies and communication protocols and may thus be capable of communication via a plurality of different access systems. For example, a mobile device may be provided with multi-radio capabilities, thus enabling access to services via a plurality of different radio access networks.

Heat generation of a mobile device can be related to the amount of power consumed from the power source thereof. The amount of heat generated may be reduced in certain occasions by the amount of power that is radiated out from the device, for example via the antenna thereof. Dissipation of heat is, on the other hand, a function of various characteristics of the device, such as dimensions, design and materials thereof, as well as the external temperature.

As more power consuming functions are added to the modern mobile device such as mobile phones and mobile data assistants, it becomes more difficult to pre-determine the heat build-up. Devices such as radio hardware are typically able to consume more power than is allowed on the average, which leads to the problem of excess heating if this is not somehow regulated.

Conventionally heat management is provided such that thermal testing is performed at “worst case” conditions, typically with maximum output power, high external temperature, and with maximum number of functions switched on. However, in typical operating conditions, heat build-up may be significantly less, and the performance may be unnecessarily restricted because of the preparations for the worst case scenario.

Active heat management mechanisms have been provided in association with personal computers. Typically these operate such that when a central processing unit (CPU) core is detected to be running at too high temperatures, a monitoring software begins shutting down programs. This, however, may not always be a feasible solution for mobile devices, such as mobile phones, where high reliability is required and it may not be allowed to entirely shut down an application, for example because of a possible need to make and/or receive an emergency call.

In accordance with an embodiment there is provided a mobile device comprising at least one measurement element for producing temperature measurement information. The mobile device further comprises a controller configured to control performance of at least one function of the mobile device in response to the temperature measurement information.

Another embodiment provides a method comprising producing temperature measurement information associated with a mobile device and controlling performance of at least one function of the mobile device in response to the temperature measurement information.

In a yet another embodiment a controller for a mobile device is provided, The controller is configured to receive temperature measurement information associated with the mobile device and to control performance of at least one function of the mobile device in response to the temperature measurement information.

In a more specific embodiment the controller dynamically adjusts the performance of at least one radio part of the mobile device. The controller may be configured to decide the necessary control action based on a total heating value computed based on a plurality of temperature measurements. The controller may also be configured to determine an allowed maximum average power consumption for the entire mobile device.

The controller may allow or disallow functions, either entirely or partially, in response to the temperature measurement information.

The controller may adjust at least one of a data rate, a duty cycle and output power.

The controller may check if a request for a higher performance can be allowed based on the temperature measurement information.

The controller may control the performance iteratively.

The at least one measurement element may comprise a temperature sensor adapted to measure at least one of a temperature of an internal component of the mobile device, a temperature within the housing of the mobile device and a temperature outside of the housing of the mobile device.

The mobile device may comprise a power management entity. In such instance the controller may be configured to inform the power management entity of a maximum allowed power based on the temperature measurement information.

The mobile device may comprise a mobile station.

For a better understanding of the present invention and how the same may be carried into effect, reference will now be made by way of example only to the accompanying drawings in which:

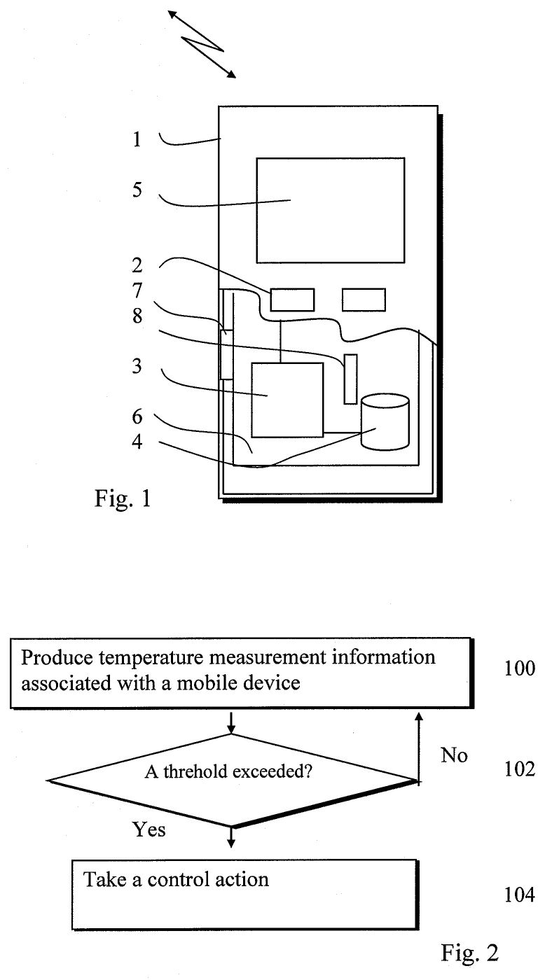

FIG. 1 shows a schematic sectioned view of a communication device; and

FIGS. 2 to 4 show flowcharts in accordance with some embodiments.

Before explaining in detail certain possible embodiments, a mobile communication device providing mobility for the users thereof is briefly explained. A mobile device such as a mobile device 1 of FIG. 1 can be used for accessing a communications system via a wireless interface between the mobile device and at least one base station of the communications system. A mobile communication device may be provided by any appropriate device capable of at least sending or receiving radio signals. Non-limiting examples include a mobile station (MS), a portable computer provided with a wireless interface card, personal data assistant (PDA) provided with wireless communication capabilities, or any combinations of these or the like.

A mobile communication device within a radio access network may communicate with the radio network via radio channels which are typically referred to as radio bearers. The communication occurs via an appropriate interface arrangement that may be provided e.g. by means of an antenna that may be internal or external. Each mobile device may have one or more radio channels open at any one time with the radio network controller. The mobile devices may be enabled for packet data communications via a communications system. A mobile device may use various applications based on appropriate protocols, for example a plurality of wireless communications protocols and/or the mobile internet protocol (IP).

The mobile device 1 of FIG. 1 can be used for various tasks such as making and receiving phone calls, for receiving and sending data from and to a network and for experiencing, for example, multimedia or other content. A mobile device is typically provided with at least one processor 3 and at least one memory 4 for performing the tasks it is designed to perform. The required processing and storage functions can be provided on appropriate circuit boards and/or chipsets. These are designated by reference 6 in FIG. 1.

The user may control the operation of the mobile device by means of a suitable user interface such as key pad 2, voice commands, touch sensitive screen or pad, combinations thereof or the like. A display 5, a speaker and a microphone are also typically provided. Furthermore, a mobile device may comprise appropriate interfaces for connection (either wired or wireless) to other devices and/or for connecting external accessories, for example hands-free equipment, thereto.

A mobile device may be enabled to access a number of different access networks. A mobile device may be allowed to choose if a particular communication is to be routed via e.g. via a cellular mobile network or a wireless local area network. The different access networks can be based on different access technologies. The mobile device 1 may be configured accordingly for enabling access via each of the access networks, for example based on an appropriate multi-radio implementation.

As is clear from the above description of exemplifying possible functions of a mobile device, a substantial number of different features and hardware may be provided in a mobile device. These consume power and produce heat.

An appropriate thermometer arrangement consisting of at least one temperature measurement element is provided for measuring the temperature of the mobile device 1. The measurement is provided in at least one part of the device. In the example of FIG. 1 temperature sensor elements 7 and 8 are shown. Of these sensor element 7 measures the temperature of the housing of the mobile device and sensor element 8 measures the temperature of the circuit board 6. It is also possible to measure the external temperature of the device as well. The temperature measurement may be a continuous process or the measurements may be performed periodically.

In an embodiment the controller 3 of the mobile device 1 is configured to monitor the temperature of the device as measured by at least one temperature measurement element. The controller is further configured to take necessary action to reduce the performance of at least one function of the mobile device in order to lessen heat generation in response to detection that at least one temperature measurement indicates overheating or at least a possibility of overheating.

In an embodiment the performance of a radio part of the mobile device 1 is dynamically increased or decreased based on measured information regarding the temperatures in at least one part of the device. The decision making may be based on a total device heating value computed based on a number of measurements. An algorithm for determining an allowed maximum average power consumption for the whole device can be provided in the processor 3 of the device 1.

The processor may also adjust the performance by allowing or disallowing various functions of the device depending on the measured heating information. Running of selected functions may be allowed or disallowed only partially, or the controller may decide to shut a function down or allow running of a particular function in its entirety.

The method implemented by the algorithm is illustrated in FIG. 2. As shown in 100, temperature measurement information associated with a mobile device is produced. Typically the information would be produced while the mobile device is in an active state. A processor of the mobile device controls the performance of at least one function of the mobile device by comparing the information to at lest one predefined threshold at 102 and taking necessary controls actions at 104 response to the temperature measurement information, for example in detection of a too high temperature value in at lest one part of the mobile device.

Examples of performance parameters that can be adjusted include data rate, duty cycle, the number of GSM slots that can be active, and output power. Total shut down of low-priority functions, for example data connection during an emergency call, sending of keep alive or other dummy messages and so on, may also be instructed. The duty cycle, data rate, and output power are each a direct contributor to the total power consumption of a radio entity. For example, the duty cycle can be adjusted by changing the number of active slots in a frame. Adjustment of data rates is also a relatively straightforward concept, since, for example, operations such as baseband and medium access control (MAC) processing, higher layer processing and writing to and reading from a memory require more activity if there is more data to process. Regulating output power in random access systems such as a wireless local area network (WLAN) is also relatively easy to implement. Transmitting at lower than maximum power may make the signal more prone to interference, but nevertheless saves a significant amount of power.

It is also possible to have different control classes for different heat conditions and/or environments. For example, it is possible to employ different thresholds such that each threshold triggers a different action. For example, a first relative low temperature threshold may trigger a first type of action and then if another, more critical threshold is reached this triggers a more drastic action. The actions to be triggered in response to a different threshold can be sorted based on an priority order thereof. For example, a threshold for “comfortable” operation may be provided. If the temperature rises above that threshold then file transfer data links may be reduced in data rate. If someone was making for example an emergency call in a lot hotter conditions, another threshold triggering the shut down of all other functions than what is required for the emergency call in order to guarantee the call.

It is noted that the above describes a heat based control in the context of reducing the performance. However, the same principle can be used in enhancing the performance of a device. For example, until the “comfortable” threshold is exceeded, the device could use all of the bandwidth the user wants. Exceeding the threshold may then trigger reduction of the performance to a “normal” level. For example radio chipsets are typically capable of performing better than what small mobile communication devices provided with a relatively small heat capacity in reality allow the chipsets to perform. Thus the performance of the mobile devices can be improved by the heat based control without a need for a higher performance radio chipsets.

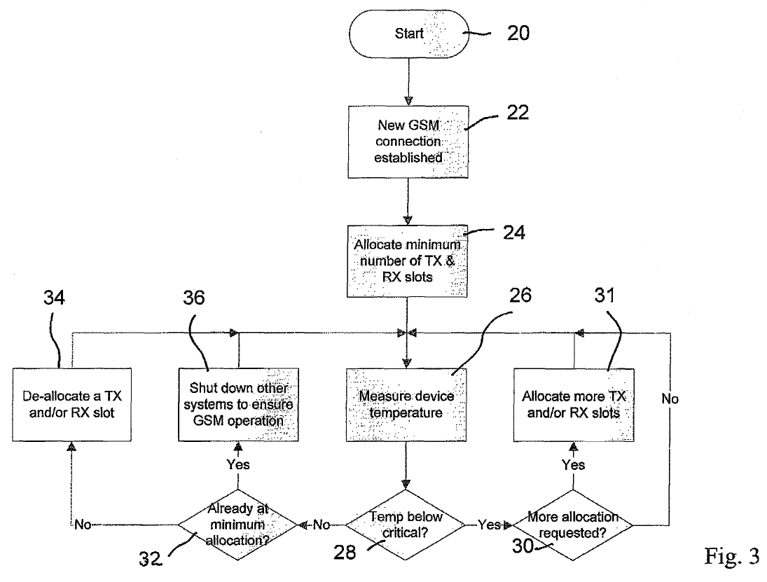

FIG. 3 shows a detailed example of an algorithm than may be employed in a performance control mechanism in accordance with an embodiment. The exemplifying algorithm is described in relation to a mobile device configured for communication via a cellular mobile network, more particularly with reference to a mobile device configured for accessing communication services via the global system for mobile communications (GSM). However, it shall be understood that this is an example only, and that similar principles apply to any mobile device configured for communication via a communication system.

FIG. 3 illustrates an iterative algorithm, where temperature of a mobile device is monitored and performance thereof is adjusted accordingly. In the example the performance parameter to be adjusted is the number of active slots in a GSM frame. For example, if a connection manager requests for more active slots, it is checked if the device temperature allows the request. If the answer is positive, the request is fulfilled.

More particularly, after the mobile device is switched on at 20, a new connection based on GSM access may be established at 22. A minimum number of GSM transmit/transmitter (TX) and receive/receiver (RX) slots is allocated for the connection at 24. At least one temperature measurement is performed during the connection at 26. The temperature monitoring may be continuous. Alternatively, the monitoring may be performed periodically. According to a yet another possibility, the monitoring is periodic unless an increase in the temperature is detected, where after the monitoring is switched into a continuous mode.

If the temperature is below a set threshold value at 28, no action may be required, and the mobile device may continue its normal operation. If it is detected at 30 that more slot allocations are required, more slots may then be allocated at 31 as there is no imminent risk of overheating. Otherwise the algorithm returns to the monitoring state of blocks 26 and 28.

If, however, the temperature exceeds the threshold value at 28, it is then checked at 32 if the slot allocation is already at its minimum. If not, then the number of transmit/transmitter (TX) and/or receive/receiver (RX) slot allocations is reduced at 34 by a predefined amount. The appropriate amount of adjustment depends on the system. The algorithm may then return to the monitoring state of blocks 26 and 28.

The reductions at 34 may occur incrementally, i.e., after a reduction of a predefined amount another adjustment round via 26, 28 and 32 follows to see if the previous reduction helped the situation or not. According to another possibility a de-allocation at 34 results a minimum possible allocation of slots, thus resulting an immediate drop to the lowest possible performance.

If the slot allocation is already at its minimum at 32, a decision may be made to shut down other systems and/or radio access functions at 36 to ensure the GSM basic operation. For example, any secondary communication channels and/or external devices will be disallowed, either entirely or at least partially. This kind of operation may be needed case in extreme operating conditions and heat build-up. Although not shown, once the situation is over, these systems can be restarted after detection at 28 that the temperature is below a safe threshold.

It is noted that the algorithm of the example of FIG. 3 is not sensitive to the amount of power that is actually consumed, but concentrates only to the problems caused by the heating. However, additional steps and parameters may be added, for example for the purposes of lengthening and/or optimising battery life or for optimising some other features of the mobile device.

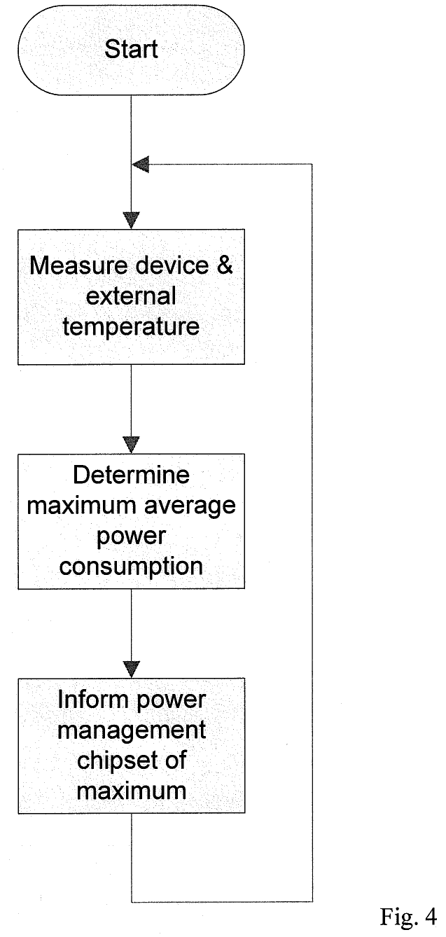

An example of a possible proactive algorithm for a system employing an intelligent power management entity, for example an appropriate chipset, is illustrated in FIG. 4. The temperature may be monitored continuously, i.e. in real time, or periodically at 42 and the measurement may be obtained from a plurality of locations. Based on the temperature readings, the system calculates at 44 a maximum power consumption value. The calculated value is then passed to an intelligent power management entity at 46.

Individual functions of a mobile device generally have a known power consumption figure, although it can vary over time. For example, if a GSM enabled device is allocated a maximum of x amperes of current, the device can internally use as many transmit/transmitter (TX) and receive/receiver (RX) slots as it wants, as long as the set current consumption threshold is not exceeded.

The period of the measurements and/or monitoring may be restricted by a sampling clock frequency. It is noted that the temperature gradients over time may not be especially steep at the cover of a mobile device, but can be relatively steep within the internal components thereof, for example inside application specific integrated circuits (ASICs), perhaps most notably in a power amplifier chip. Therefore continuous, or very frequent, measurements and monitoring may not be necessary for the user-experienced heating on the outer cover, but may nevertheless be required for the internal components of the device.

The required data processing functions may be provided by means of one or more data processors provided in the mobile device. Appropriately adapted computer program code product may be used for running the algorithms, when loaded to a processor of the mobile device. The processor for running the program code in a mobile device may be integrated with the existing processor of the mobile device. The program code product may, for example, perform the operation of monitoring and decision making, and of generation of messages and/or information elements required to perform the described control operation. The program code product for providing the operation may be stored on and provided by means of a carrier medium such as a carrier disc, card or tape. A possibility is to download the program code product to the mobile device via a data network.

The algorithm may be implemented by means of a multitask or an intelligent radio control software adapted to encompass radio frequency (RF) and baseband control and also to be co-operative with the available communication protocols. Such a multitask radio control software is believed to provide a good example of enabling technologies that may be required in certain applications since the traditional “protocol controls the hardware” approach of the mobile communication devices may not always be suitable for incorporating a new type of control scheme like the one described above. This may be due to various reasons, for example because of the non-visibility of the actual operating conditions to the protocol. Thus, more intelligence may be required in the lower level controlling entities, especially in a multi-mode, multi-radio device. It may not be feasible to have a separate chipset for each protocol in a mobile communication device enabled to operate in accordance with a number of different protocols. Instead, resource sharing may be required. Thus low-level resource management software that is co-operative with the protocols, or an intelligent radio control software, may be used to enable application of the embodiments in such devices.

Above described embodiments may enable high local optimization in performance versus power consumption. The embodiment may be especially suitable in multi-radio terminals. The embodiments may allow a better radio performance, for example data rate/bandwidth performance, in normal operation conditions than what is obtainable based on arrangements that are based a fixed “worst case” scenario.

It is noted that whilst embodiments of the present invention have been described in relation to devices such as mobile user equipment, embodiments of the present invention are applicable to any other suitable type of mobile devices suitable for sending and/or receiving communication, for example data downloads. Thus it is evident that the invention is not necessarily limited to devices provided with radio capabilities. Other possible mobile devices, for example MP3 (moving picture expert's group layer-3 audio) players, mobile multimedia terminals and so on, may also be provided with a similar heat based performance optimisation mechanism.

It is also noted that although certain embodiments are described herein by way of example, with reference to the exemplifying architectures of a communication system comprising certain mobile communication technologies, embodiments may be applied to any other suitable forms of communication systems and devices than those illustrated and described herein. For example, the device may be configured for use in association with technologies such as UWB (Ultra Wide Band), or short range links such as the Bluetooth™ (a short range radio link), WiMax (Worldwide Interoperability for Microwave Access), or the Rfid (radio frequency identification), an infrared link, and so forth. It is also noted herein that while the above describes exemplifying embodiments of the invention, there are several variations and modifications which may be made to the disclosed solution without departing from the scope of the present invention as defined in the appended claims.

1. A mobile device comprising:
at least one measurement element for producing temperature measurement information; and
a controller configured to control performance of at least one function of the mobile device in response to the temperature measurement information.

2. A mobile device as claimed in claim 1, wherein the controller is configured to dynamically adjust the performance of at least one radio part of the mobile device.

3. A mobile device as claimed in claim 1, wherein the controller is configured to decide the necessary control action based on a total heating value computed based on a plurality of temperature measurements.

4. A mobile device as claimed in claim 1, wherein the controller is configured to determine an allowed maximum average power consumption for the entire mobile device.

5. A mobile device as claimed in claim 1, wherein the controller is configured to allow or disallow functions of the mobile device in response to the temperature measurement information.

6. A mobile device as claimed in claim 1, wherein the controller is configured to partially allow or disallow functions of the mobile device in response to the temperature measurement information.

7. A mobile device as claimed in any preceding claim 1, wherein the controller is configured to adjust at least one of a data rate, a duty cycle and output power.

8. A mobile device as claimed in claim 1, wherein the controller is configured to check if a request for a higher performance can be allowed based on the temperature measurement information.

9. A mobile device as claimed in claim 8, wherein the controller is configured to check if a request for more active slots per frame is allowable.

10. A mobile device as claimed in claim 1, wherein the controller is configured to control the performance iteratively.

11. A mobile device as claimed in claim 1, wherein the at least one measurement element comprises a temperature sensor adapted to measure at least one of a temperature of an internal component of the mobile device, a temperature within the housing of the mobile device and a temperature outside of the housing of the mobile device.

12. A mobile device as claimed in claim 1, comprising a power management entity, wherein the controller is configured to inform the power management entity of a maximum allowed power based on the temperature measurement information.

13. A mobile device as claimed in claim 1, wherein the controller is configured to change the number of active slots in a transmission frame.

14. A mobile device as claimed in claim 13, wherein the controller is configured to change the allocation of at least one of active transmission slots and active reception slots.

15. A mobile device as claimed in claim 1, wherein the controller comprises a low-level resource management program code configured to be co-operative with at least one communication protocol.

16. A mobile device as claimed in claim 1, wherein the controller is configured to treat measurement information from a measurement element differently from measurement information from another measurement element.

17. A mobile device as claimed in claim 1, wherein the controller is configured to control the performance based on at least two different control classes.

18. A mobile device as claimed in claim 1, comprising a mobile station configured for communication via at least one of a mobile communication network, a wireless local area network and a short range communication link.

19. A method comprising:
producing temperature measurement information associated with a mobile device; and
controlling performance of at least one function of the mobile device in response to the temperature measurement information.

20. A method as claimed in claim 19, wherein the controlling comprises dynamically adjusting the performance of at least one radio part of the mobile device.

21. A method as claimed in claim 20, wherein the adjusting comprises changing of the number of active slots allocated for a frame.

22. A method as claimed in claim 19, comprising computing a total heating value based on a plurality of temperature measurements, wherein the controlling comprises determining and performing a control action based on the total heating value.

23. A method as claimed in claim 19, comprising determining an allowed maximum average power consumption for the entire mobile device.

24. A method as claimed in claim 19, comprising allowing or disallowing functions of the mobile device in response to the temperature measurement information.

25. A method as claimed in claim 19, comprising partially allowing or disallowing functions of the mobile device in response to the temperature measurement information.

26. A method as claimed in claim 19, wherein the controlling comprises adjusting at least one of a data rate, a duty cycle and output power.

27. A method as claimed in claim 19, wherein the controlling comprises checking if a request for a higher performance can be allowed based on the temperature measurement information.

28. A method as claimed in claim 19, wherein the controlling comprises iteratively adjusting at least one performance parameter of the mobile device.

29. A method as claimed in claim 19, wherein the temperature measurement information is produced and the performance is controlled in parallel with communication by the mobile device via at least one of a mobile communication network, a wireless local area network and a short range communication link.

30. A method as claimed in claim 19, comprising determining a value for maximum average power consumption and informing a power management entity of the mobile device of the determined value.

31. A method as claimed in claim 19, wherein the controlling comprises controlling the performance based on at least two different control classes.

32. A program code product comprising program code means adapted to perform any of steps of claim 19 when the program is run on a processor.

33. A controller for a mobile device configured to receive temperature measurement information associated with the mobile device, and to control performance of at least one function of the mobile device in response to the temperature measurement information.

34. A controller of claim 33 comprising a chip for a mobile communication device.
